(19) United States
(12) Patent Application Publication
(10) Pub. No.: US 2015/0323756 A1
(43) Pub. Date: Nov. 12, 2015

(54) OPTICAL LENS AND A METHOD FOR MANUFACTURING THE SAME

(71) Applicant: Genius Electronic Optical Co., Ltd., Central Taiwan Science Park (TW)

(72) Inventors: Hung-Chang CHO, Central Taiwan Science Park (TW); Yi-Man DENG, Xiamen (CN); Hai-Bin ZHAN, Xiamen (CN); Zhen-Mu CHEN, Xiamen (CN); Qing-Shu YE, Xiamen (CN)

(21) Appl. No.: 14/477,993

(22) Filed: Sep. 5, 2014

(30) Foreign Application Priority Data
May 9, 2014 (CN) 201410194249.0

(51) Int. Cl. G02B 7/02; B29C 45/00

(52) U.S. Cl. CPC G02B 7/021; B29C 45/0003; B29D 11/00403

(57) ABSTRACT

An optical lens includes a barrel and a protruding boss unit. The barrel defines a receiving space in which a plurality of components are disposed and arranged along an axis, and includes a front wall. Each of the front wall and the components has front and rear confronting surfaces opposite to each other along the axis. The protruding boss unit is formed on and protrudes from one of the adjacent two front and rear confronting surfaces, and abuts against the other one of the adjacent two front and rear confronting surfaces. The other one of the front and rear confronting surfaces abutted by the boss unit is flat.

### CROSS-REFERENCE TO RELATED APPLICATION

This application claims priority to Chinese Application No. 201410194249.0, filed on May 9, 2014.

### BACKGROUND OF THE INVENTION

1. Field of the Invention

The present invention relates to an optical lens, more particularly to an optical lens including a protruding boss unit for correcting tilt of components of the optical lens and a method for manufacturing the optical lens.

2. Description of the Related Art

In recent years, as use of optical lens modules in portable electronic devices (e.g., digital cameras, tablet computers and mobile phones) becomes ubiquitous, much effort has been put into improving optical performance of the optical lens modules. In addition to the design for components of the optical lens module, assembling process of the components is also critical to optical performance.

Referring to FIGS. 1 and 2, a conventional optical lens includes a barrel 11 defining an optical axis (A), and a plurality of optical lens components 12 disposed in the barrel 11 and arranged along the optical axis (A). In order to reduce tilt of each of the optical lens components 12 relative to the optical axis (A), which adversely affects optical performance of the optical lens, the optical lens components 12, which are, for example, made of glass, are individually shaped by a relatively complex process such as a grinding procedure. However, it is troublesome to fine-tune each of the optical lens components 12. Therefore, an injection molding process is employed, with respective molds, to form the barrel 11 and the lens components 12. However, since every adjacent two optical lens components 12 are in contact with each other by a relatively large area therebetween, it is relatively troublesome and difficult to correct tilt of each optical lens component 12 relative to the optical axis (A) by adjusting the molds for forming all of the optical lens components 12.

### SUMMARY OF THE INVENTION

Therefore, an object of the present invention is to provide an optical lens including a protruding boss unit for correcting tilt of components of the optical lens.

According to one aspect of the present invention, an optical lens includes a barrel, a lens assembly, a plurality of annular confronting-surface pairs, and at least one protruding boss unit. The barrel defines a receiving space and includes a front wall formed with an aperture that surrounds an optical axis. The lens assembly includes a plurality of components disposed in the receiving space and arranged along the optical axis. Each of the front wall and the components has front

and rear confronting surfaces that are opposite to each other along the optical axis. One of the annular confronting-surface pairs is disposed between the front wall of the barrel and one of the components, which is in closest proximity to the front wall, and consists of the rear confronting surface of the front wall and the front confronting surface of the one of the components. Each of the other ones of the annular confronting-surface pairs is disposed between adjacent two of the components, and consists of the front confronting surface of a rear one of the adjacent two of the components and the rear confronting surface of a front one of the adjacent two of the components. The protruding boss unit is formed on one of the front and rear confronting surfaces of one of the annular confronting-surface pairs, and includes at least one boss element that protrudes from the one of the front and rear confronting surfaces along a direction parallel to the optical axis and that abuts against the other one of the front and rear confronting surfaces of the one of the annular confronting-surface pairs. The other one of the front and rear confronting surface abutted by the protruding boss unit is flat.

According to another object of this invention, a method for manufacturing an optical lens includes the following steps of: a) forming, by an injection molding process with respective molds, a plurality of pieces, the pieces including a barrel that includes a front wall formed with an aperture surrounding an optical axis and that defines a receiving space, and a plurality of components of a lens assembly, at least one of the pieces being formed with a boss unit; b) arranging the components in the receiving space along the optical axis to constitute the lens assembly; wherein, in step a): each of the front wall and the components is formed to have front and rear confronting surfaces that are opposite to each other along the optical axis; for the front wall of the barrel and one of the components, which is in closest proximity to the front wall, and for every adjacent two of the components, a respective annular confronting-surface pair is defined therebetween, the annular confronting-surface pair formed between the front wall of the barrel and said one of the components in closest proximity to the front wall consists of the rear confronting surface of the front wall and the front confronting surface of said one of the components; the annular confronting-surface pair formed between the adjacent two of the components consists of the front confronting surface of a rear one of the adjacent two of the components and the rear confronting surface of a front one of the adjacent two of the components; and the protruding boss unit is formed on one of the front and rear confronting surfaces of one of the annular confronting-surface pairs, and is formed to include at least one boss element protruding from the one of the front and rear confronting surfaces along a direction parallel to the optical axis and abutting against the other one of the front and rear confronting surfaces of the one of the annular confronting-surface pairs, the other one of the front and rear confronting surfaces abutted by the boss unit being formed to be flat; c) after steps a) and b), measuring tilt of each of the components relative to the optical axis and re-configuring one of the molds used to form said one of the pieces, which is formed with the boss unit; and d) using the mold re-configured in step c) to form another piece with a boss unit that compensates tilt of the components of the lens assembly.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional optical lens;

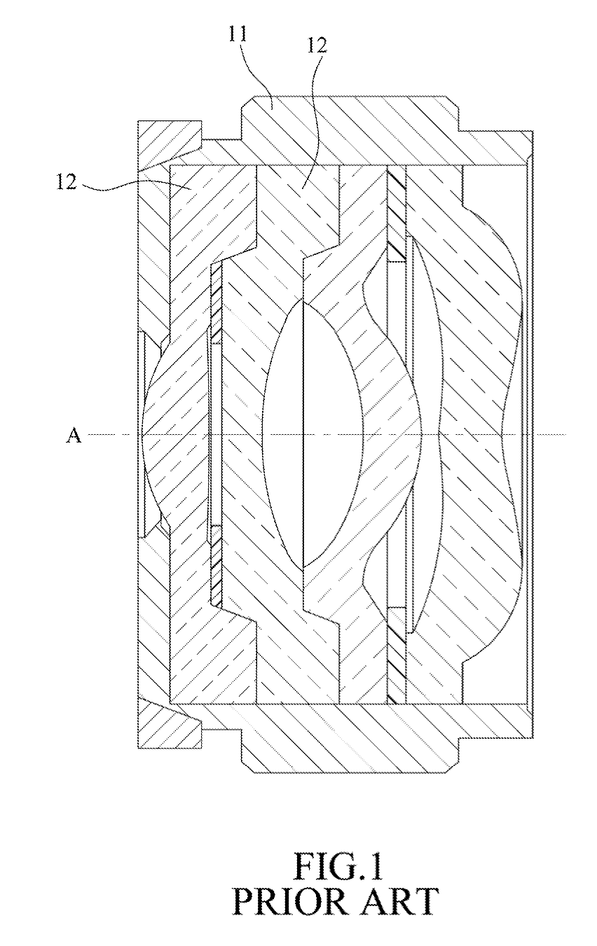

FIG. 2 is a schematic exploded schematic view of the conventional optical lens;

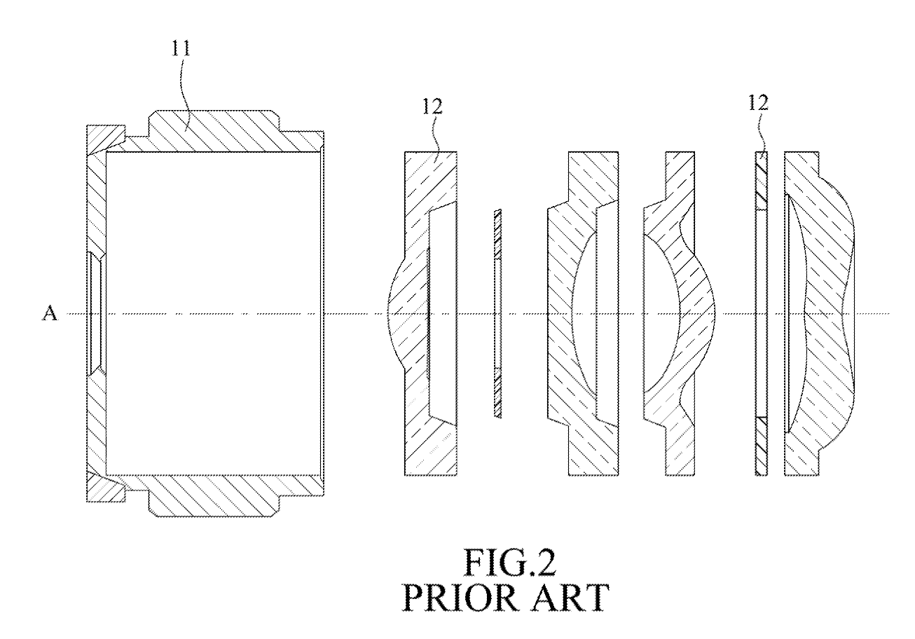

FIG. 3 is an exploded sectional view of a lens assembly of an optical lens of a preferred embodiment according to the present invention;

FIG. 4 is a sectional view of the preferred embodiment, illustrating components of the lens assembly after being assembled;

FIG. 5 is a schematic front view of the preferred embodiment, illustrating a plurality of protruding boss units isogonally spaced apart from one another about an optical axis; and

FIG. 6 is a flow chart of a method for manufacturing the optical lens according to the preferred embodiment of the present invention.

### DETAILED DESCRIPTION OF THE PREFERRED EMBODIMENT

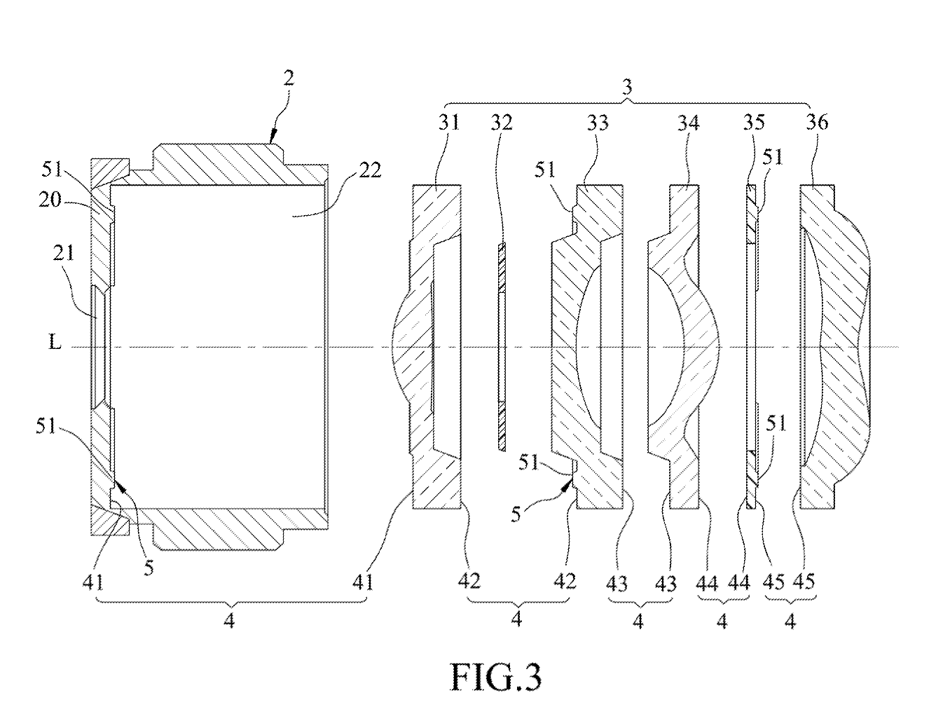

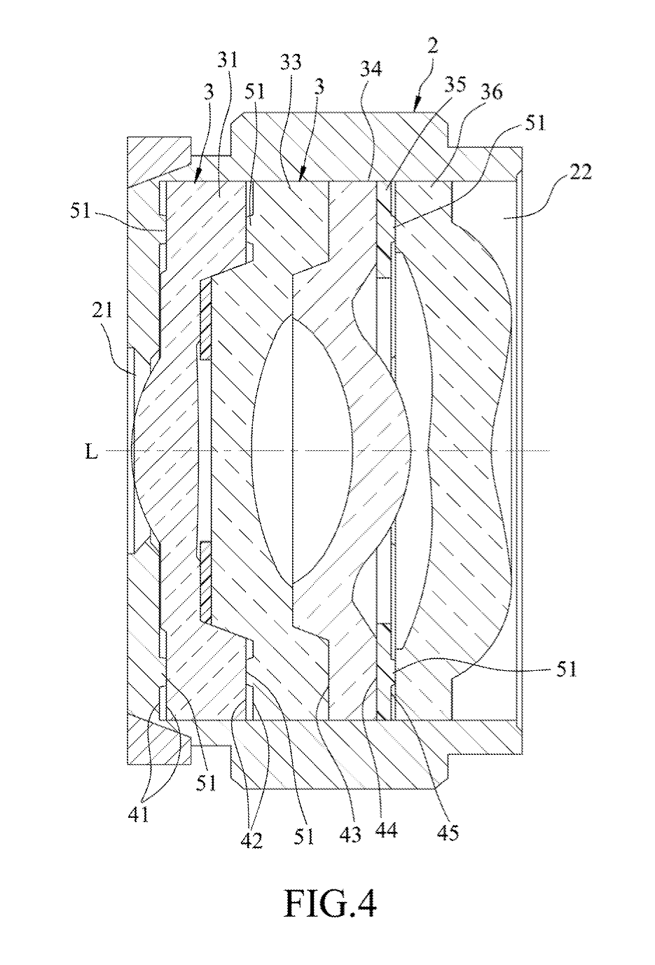

Referring to FIGS. 3 to 5, the preferred embodiment of an optical lens according to the present invention includes a barrel 2, a lens assembly, a plurality of annular confronting-surface pairs 4, and a plurality of protruding boss units 5. The barrel 2 includes a front wall 20 formed with an aperture 21, which surrounds an optical axis (L), and defines a receiving space 22. The lens assembly includes a plurality of components 3 disposed in the receiving space 22. In this embodiment, the components 3 of the lens assembly include a first optical lens component 31, a light shielding sheet 32, a second optical lens component 33, a third optical lens component 34, a spacer 35 and a fourth optical lens component 36 that are arranged in order along the optical axis (L). Note that the number and arrangement of the components 3 of the lens assembly may vary in other embodiments of this invention, and should not be limited to what is disclosed herein.

Each of the front wall 20 and the components 3 has front and rear confronting surfaces that are opposite to each other along the optical axis (L). The annular confronting-surface pairs 4 include first to fifth annular confronting-surface pairs 41 to 45. Specifically, the first annular confronting-surface pair 41 is disposed between the front wall 20 of the barrel 2 and the first lens component 31, which is in closest proximity to the front wall 20, and consists of the rear confronting surface of the front wall 20 and the front confronting surface of the first lens component 31. Each of the second to the fifth annular confronting-surface pairs 42 to 45 is disposed between adjacent two of the components 3, and consists of the front confronting surface of a rear one of the adjacent two of the components 3 and the rear confronting surface of a front one of the adjacent two of the components 3. That is to say, the second annular confronting-surface pair 42 is disposed between the first optical lens component 31 and the second optical lens component 33, the third annular confronting-surface pair 43 is disposed between the second optical lens component 33 and the third optical lens component 34, the fourth annular confronting-surface pair 44 is disposed between the third optical lens component 34 and the spacer 35, and the fifth annular confronting-surface pair 45 is disposed between the spacer 35 and the fourth optical lens component 36.

Each of the protruding boss units 5 is formed on one of the front and rear confronting surfaces of one of the annular confronting-surface pairs 4. In this embodiment, the number of the protruding boss units 5 is three, and the protruding boss units 5 are formed on the first annular confronting-surface pair 41, the second annular confronting-surface pair 42, and the fifth annular confronting-surface pair 45, respectively. Adjacent two of the protruding boss units 5 are misaligned with each other in a direction along the optical axis (L).

Each of the protruding boss units 5 includes a plurality of boss elements 51. The boss elements 51 protrude from the one of the front and rear confronting surfaces along a direction parallel to the optical axis (L), and abut against the other one of the front and rear confronting surfaces. The other one of the front and rear confronting surface abutted by the boss element 51 is flat. More particularly, in this embodiment, the boss elements 51 of one of the protruding boss units 5, which is formed on the first annular confronting-surface pair 41, protrude from the rear confronting surface of the front wall 20 along the direction parallel to the optical axis (L), and abut against the front confronting surface of the first lens component 31 that is configured to be flat. The boss elements 51 of another one of the protruding boss units 5, which is formed on the second annular confronting-surface pair 42, protrude from the front confronting surface of the second optical lens component 33 along the direction parallel to the optical axis (L), and abut against the rear confronting surface of the first optical lens component 31 that is configured to be flat. The boss elements 51 of yet another one of the protruding boss units 5, which is formed on the fifth annular confronting-surface pair 45, protrude from the rear confronting surface of the spacer 35 along the direction parallel to the optical axis (L), and abut against the front confronting surface of the fourth optical lens component 36 that is configured to be flat. Note that the protruding boss units 5 may be formed on the third and fourth annular confronting-surface pairs 43, 44 and are not limited to the specific configuration of this embodiment.

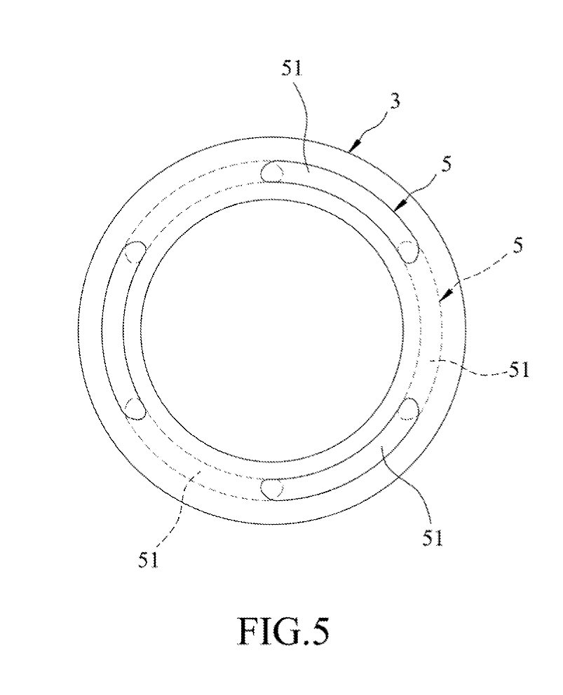

Preferably, as shown in FIG. 5, the number of the boss elements 51 of each protruding boss unit 5 is three. The boss elements 51 are isogonally spaced apart from one another about the optical axis (L), and extend curvedly with respect to the optical axis (L). It should be noted that the number and the configuration of the boss elements 51 may be varied and should not be limited to this embodiment. For example, there may be only one boss element 51 formed on the third annular confronting-surface pair 43, protruding from the second optical lens component 33, and abutting against the third optical lens component 34. Alternatively, the boss element 51 may be formed on the fourth annular confronting-surface pair 44, protruding from the spacer 35, and abutting against the third optical lens component 34.

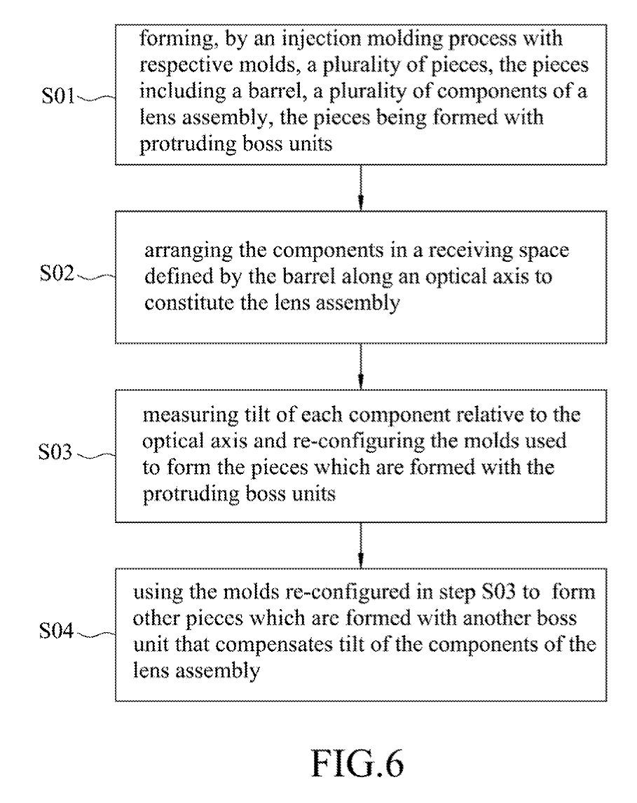

Referring to FIG. 6, a method for manufacturing the optical lens according to the preferred embodiment of the present invention is disclosed to include the following steps. In step S01, a plurality of pieces including the barrel 2, and the components 3, are formed by an injection molding process through a plurality of molds, in which the protruding boss units 5 are formed on one of the pieces, The barrel 2 is formed to include the front wall 20 formed with the aperture 21 surrounding the optical axis (L) and to define the receiving space 22.

In step S02, the components 3 are disposed and arranged in the receiving space 22 along the optical axis (L) to constitute the lens assembly.

Note that in step S01, the protruding boss units 5 are formed on the first, second and fifth annular confronting-surface pairs 41, 42 and 45, respectively. The boss elements 51 of the protruding boss unit 5 that is disposed on the first annular confronting-surface pair 41 protrude from the rear confronting surface of the front wall 20 of the barrel 2 along the direction parallel to the optical axis (L). The boss elements 51 of the protruding boss unit 5 that is disposed on the second annular confronting-surface pair 42 protrude front the front confronting surface of the second optical lens component 33 along the direction parallel to the optical axis (L). The boss elements 51 of the protruding boss unit 5 that is disposed on the fifth annular confronting-surface pair 45 protrude from the rear confronting surface of the spacer 35 along the direction parallel to the optical axis (L). After step S02, the boss elements 51 of the respective boss units 5 abut against the front confronting surface of the first optical lens component 31, the rear confronting surface of the first optical lens component 31, and the front confronting surface of the fourth optical lens component 36.

Subsequent to steps S01 and S02, in step S03, tilt of each component 3 relative to the optical axis (L) is measured, and the molds used to form the pieces, which are formed with the protruding boss units 5, are re-configured for forming the pieces which are formed with at least one modified protruding boss unit 5 that compensates tilt of the components 3. In step S04, the molds re-configured in step S03 are used to form the pieces which are formed with said at least one modified protruding boss unit 5 that compensates tilt of the components 3.

To sum up, some of the advantages of the optical lens of the present invention are as follows. Since all the components used in the optical lens are formed by an injection molding process, it is relatively simple to manufacture and assemble the components of the optical lens. Further, when it is desired to correct tilt of the components 3 of the lens assembly relative to the optical axis (L), only the molds for forming the pieces which are formed with the protruding boss units 5 are required to be modified to form the pieces which are formed with at least one modified protruding boss unit 5 that compensates tilt of the components 3, which results in a relatively simple correcting procedure. Finally, the configuration of the boss elements 51 that are isogonally spaced apart from one another about the optical axis (L) and the adjacent two of the protruding boss units 5, which form on difference annular confronting-surface pairs, that are misaligned with each other in the direction along the optical axis (L) provides a relatively stable connection among the components 3 of the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An optical lens comprising:
a barrel including a front wall formed with an aperture that surrounds an optical axis, said barrel defining a receiving space;
a lens assembly including a plurality of components that are disposed in said receiving space and that are arranged along the optical axis, each of said front wall and said components having front and rear confronting surfaces that are opposite to each other along the optical axis;
a plurality of annular confronting-surface pairs, wherein one of said annular confronting-surface pairs is disposed between said front wall of said barrel and one of said components, which is in closest proximity to said front wall, and consists of said rear confronting surface of said front wall and said front confronting surface of said one of said components, wherein each of the other ones of said annular confronting-surface pairs is disposed between adjacent two of said components, and consists of said front confronting surface of a rear one of said adjacent two of said components and said rear confronting surface of a front one of said adjacent two of said components; and
at least one protruding boss unit formed on one of said front and rear confronting surfaces of one of said annular confronting-surface pairs, and including at least one boss element that protrudes from said one of said front and rear confronting surfaces along a direction parallel to the optical axis and that abuts against the other one of said front and rear confronting surfaces of said one of said annular confronting-surface pairs, the other one of said front and rear confronting surfaces abutted by the protruding boss unit being flat.

2. The optical lens as claimed in claim 1, wherein said protruding boss unit includes a plurality of said boss elements.

3. The optical lens as claimed in claim 2, wherein the number of said boss elements is three.

4. The optical lens as claimed in claim 2, wherein said boss elements are isogonally spaced apart from one another about the optical axis.

5. The optical lens as claimed in claim 2, wherein said boss elements extend curvedly with respect to the optical axis.

6. The optical lens as claimed in claim 1, wherein said components of said lens assembly include a spacer, and at least one optical lens component that is disposed adjacent to said spacer, and said protruding boss unit is formed on one of said front and rear confronting surfaces of a corresponding one of said annular confronting-surface pairs that is formed between said optical lens component and said spacer.

7. The optical lens as claimed in claim 1, wherein said components of said lens assembly include at least one optical lens component disposed adjacent to said barrel, and said protruding boss unit is formed on one of said front and rear confronting surfaces of a corresponding one of said annular confronting-surface pairs that is formed between said, optical lens component and said barrel.

8. The optical lens as claimed in claim 1, wherein said components of said lens assembly include at least two optical lens components, and said protruding boss unit is formed on one of said front and rear confronting surfaces of a corresponding one of said annular confronting-surface pairs that is formed between said two optical lens components.

9. The optical lens as claimed in claim 1, comprising a plurality of said protruding boss units formed on respective ones of said annular confronting-surface pairs, and adjacent two of said protruding boss units, which form on difference annular confronting-surface pairs, are misaligned with each other in a direction along the optical axis.

10. The optical lens as claimed in claim 1, wherein said protruding boss unit, said barrel, and said components of said lens assembly are formed by an injection molding process.

11. A method for manufacturing an optical lens, said, method comprising the following steps of:
a) forming, by an injection molding process with respective molds, a plurality of pieces, the pieces including a barrel that includes a front wall formed with an aperture surrounding an optical axis and that defines a receiving space, and a plurality of components of a lens assembly, at least one of the pieces being formed with a boss unit;
b) arranging the components in the receiving space along the optical axis to constitute the lens assembly; wherein, in step a):
each of the front wall and the components is formed to have front and rear confronting surfaces that are opposite to each other along the optical axis;
for the front wall of the barrel and one of the components, which is in closest proximity to the front wall, and for every adjacent two of the components, a respective annular confronting-surface pair is defined therebetween,
the annular confronting-surface pair formed between the front wall of the barrel and said one of the components in closest proximity to the front wall consists of the rear confronting surface of the front wall and the front confronting surface of said one of the components;
the annular confronting-surface pair formed between the adjacent two of the components consists of the front confronting surface of a rear one of the adjacent two of the components and the rear confronting surface of a front one of the adjacent two of the components; and
the boss unit is formed on one of the front and rear confronting surfaces of one of the annular confronting-surface pairs, and is formed to include at least one boss element protruding from the one of the front and rear confronting surfaces along a direction parallel to the optical axis and abutting against the other one of the front and rear confronting surfaces of the one of the annular confronting-surface pairs, the other one of the front and rear confronting surfaces abutted by the boss unit being formed to be flat;
c) after steps a) and b), measuring tilt of each of the components relative to the optical axis and re-configuring one of the molds used to form said one of the pieces, which is formed with the boss unit; and
d) using the mold re-configured in step c) to form another piece with a boss unit that compensates tilt of the components of the lens assembly.
